(19) United States
(12) Patent Application Publication
(10) Pub. No.: US 2004/0178096 A1
(43) Pub. Date: Sep. 16, 2004

(54) Tool suspension device

(76) Inventor: Jui-Chien Kao, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/384,591

(22) Filed: Mar. 11, 2003

(51) Int. Cl. B65D 75/00; B23Q 3/02

(52) U.S. Cl. 206/349; 269/96; 206/806

(57) ABSTRACT

A tool suspension device for pliers includes a suspension board and a holding assembly. The suspension board has a front, a right side, a left side, a top and a bottom. A handle stop is attached to the front near the right side of the suspension board. A holding assembly with a receiving hole is defined through and mounted on the front of the suspension board corresponding to the handle stop. The receiving hole of the holding assembly is adapted to tightly hold one handle of the pliers, and the handle stop is adapted to abut the other handle of the pliers on the front of the suspension board. Consequently, a person can conveniently check and operate the pliers on the tool suspension device without removing the pliers from the tool suspension device.

### BACKGROUND OF THE INVENTION

1. Field of the Invention

The present invention relates to a tool suspension device, and more particularly to a tool suspension device suitable for pliers and also suitable for a consumer to conveniently manually operate the pliers on the tool suspension device.

2. Description of Related Art

Pliers are used to grip small objects and bend or cut wire. A pair of pliers generally comprises two handles pivotally connected, jaws and a wire cutter. The jaws are used to clamp, and the wire cutter is used to cut wire. Checking the operation and condition of the jaws and the wire cutter is important before a consumer purchases the pliers.

With reference to FIG. 8, a conventional tool suspension device for pliers such as a pair of long-nose pliers (not numbered) comprises a see-through plastic case (60) and a cardboard card (61). The plastic case (60) has a cavity (not numbered) in a shape corresponding to the long-nose pliers. The plastic case (60) is attached to the cardboard card (61), and the long-nose pliers are mounted in the cavity between the plastic case (60) and the cardboard card (61). This kind of tool suspension device for pliers only allows a person to see the long-nose pliers. People who want to buy the pliers cannot grip the long-nose pliers or physically check the operation and condition of the jaws or the wire cutter of the long-nose pliers without removing the see-through case (60).

With reference to FIG. 9, another conventional tool suspension device for pliers comprises a suspension board (70) and a holder (71). The suspension board (70) has a front (not numbered), and the holder (71) is attached to the front of the suspension board (70). A receiving hole (72) is longitudinally defined through the holder (71), and a pair of pliers (not numbered) is held in the receiving hole (72). Although such a configuration holds and suspends the pliers, the suspension device still has shortcomings for some specialty pliers. A compression spring (not shown) mounted between the two handles near a pivot point of the handles is conventional. A user squeezes the handles of the pliers when performing a task, and the compression spring presses the handles apart when the handles are released. The compression spring in the pliers must normally be compressed to mount the pliers in the receiving hole (72). Lengthy compression of the compression spring may permanently deform the compression spring so it will not be able to perform its original function.

To overcome the shortcomings, the present invention provides a tool suspension device for pliers to mitigate or obviate the aforementioned problems.

### SUMMARY OF THE INVENTION

The main objective of the invention is to provide a tool suspension device for pliers so a person can conveniently check the operation and condition of pliers suspended on the tool suspension device.

Another objective of the invention is to provide a tool suspension device that is suitable to suspend pliers with a compression spring mounted between the handles.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of a tool suspension device for pliers in accordance with the present invention;

FIG. 2 is a perspective view of the tool suspension device in FIG. 1;

FIG. 3 is an operational front plan view of the tool suspension device in FIG. 1 with a pair of sidecutters mounted on the device;

FIG. 4 is an operational perspective view of the tool suspension device in FIG. 1 with a pair of needle-nose pliers mounted on the device;

FIG. 5 is an exploded perspective view of a second embodiment of the tool suspension device in accordance with the present invention;

FIG. 6 is an operational perspective view of the tool suspension device in FIG. 5 with a pair of pruning cutters mounted on the device;

FIG. 7 is an operational perspective view of a third embodiment of the tool suspension device in accordance with the present invention;

FIG. 8 is an operational perspective view of a conventional tool suspension device for pliers in accordance with the prior art; and

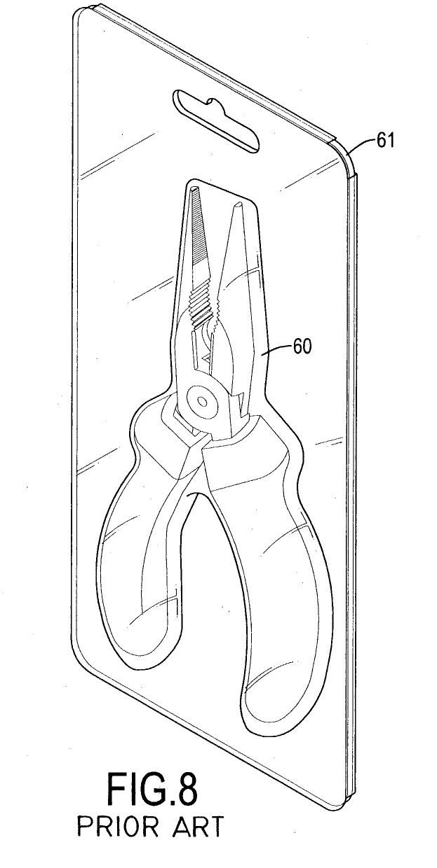

FIG. 9 is an operational perspective view of another conventional tool suspension device for pliers in accordance with the prior art.

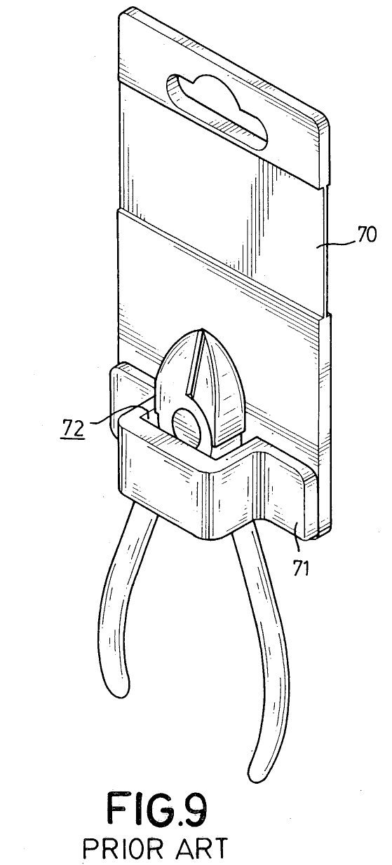

### DETAILED DESCRIPTION OF PREFERRED EMBODIMENT

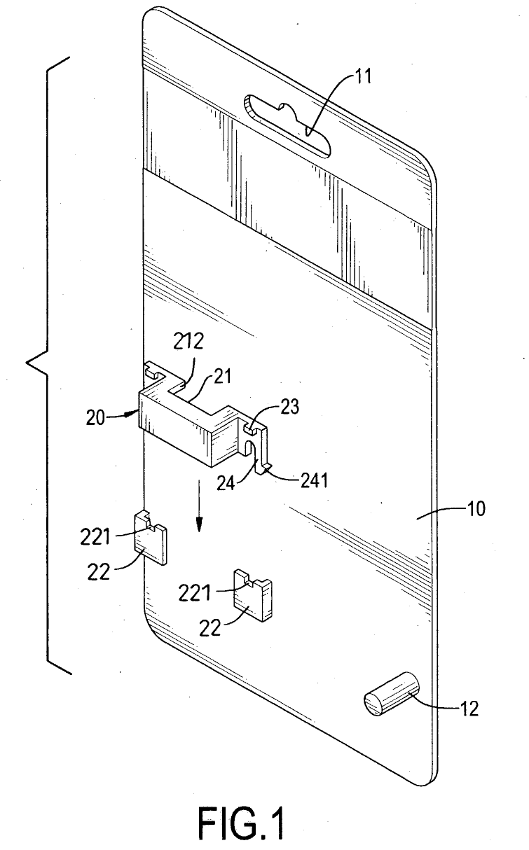

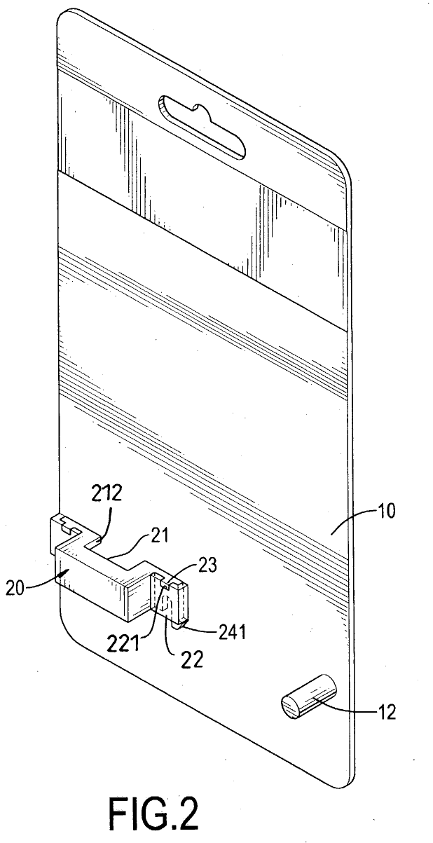

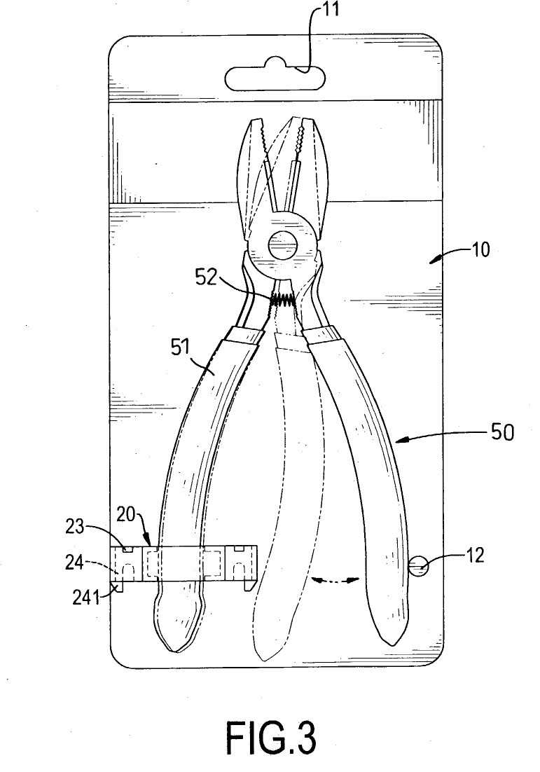

With reference to FIGS. 1 to 3, a first embodiment of a tool suspension device in accordance with the present invention comprises a suspension board (10) and a holding assembly (20). The suspension board (10) has a front (not numbered), a right side (not numbered), a left side (not numbered), a top (not numbered) and a bottom (not numbered). A hanging hole (11) is defined through the front near the top of the suspension board (10) and is adapted to hang on a display stand (not shown). A handle stop (12) is mounted on the front near the right side of the suspension board (10).

The holding assembly (20) is mounted in the front near the left side of the suspension board (10) corresponding to the handle stop (12) and cooperates with the handle stop (12) to hold a pair of the pliers (50) on the front of the suspension board (10). The pliers (50) have two handles (51) that are pivotally jointed together at a pivot point. Each handle (51) has an end (not numbered) opposite the pivot point. The holding assembly (20) comprises a bracket (21) and two holders (22). The bracket (21) has a front (not numbered), a top (not numbered), a bottom (not numbered) and two opposite sides (not numbered) and is made by the injection molded plastic. A receiving hole (212) is longitudinally defined through the top to the bottom between the two sides of the bracket (21). The receiving hole (212) of which is smaller in size than the end of the handle (51) such that the receiving hole (212) is adapted to tightly hold one of the handles (51) of the pliers (50). A positioning stub (23) protrudes from the front adjacent to the top at each side of the bracket (21). A deforming slot (not numbered) is defined from the bottom to form a resilient arm (24) at each side of the bracket (21). A hook (241) is formed on and extends from the resilient arm (24) at each side of the bracket (21).

To attach the bracket (21) to the front of the suspension board (10), the holders (22) are respectively mounted on the front of the suspension board (10) corresponding to the resilient arms (24) of the bracket (21). Each holder (22), is L-shaped, has a top (not numbered), a bottom (not numbered), a short end (not numbered) and an elongated end (not numbered). The short end of each holder (22) is attached to the front of the suspension board (10) and the elongated ends face each other. A notch (221) is defined in the top of each holder (22) corresponding to the respective positioning stub (23) on the bracket (21). The positioning stubs (23) on the bracket (21) are respectively received in the notches (221) in the holders (22), and the resilient arms (24) of the bracket (21) are respectively held between the suspension board (10) and the holders (22). The hooks (241) on the resilient arms (24) respectively engage the bottoms of the holders (22) such that the bracket (21) is securely held on the front of the suspension board (10). One of the handles (51) of the pliers (50) is mounted through and tightly held in the receiving hole (212) of the bracket (21), and the other handle (51) of the pliers (50) abuts the handle stop (12). Pliers (50) are held securely on the suspension board. Even a special pair of the pliers (50) with a compression spring (52) can be mounted easily on the suspension board. The compression spring (52) will not be compressed when the pliers (50) are mounted on the front of the suspension board (10). The pliers (50) are normally open on the suspension board (10) and can be conveniently checked without removing the pliers (50) from the suspension board (10).

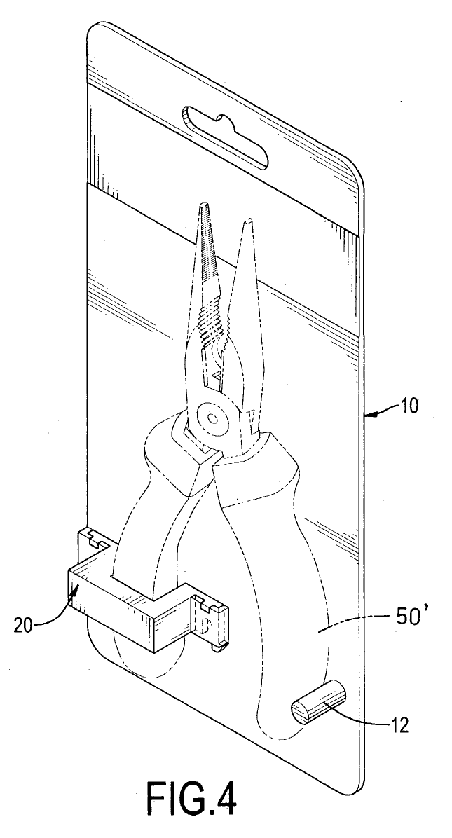

With reference to FIG. 4, other types of pliers such as a pair of needle-nose pliers (50′) without any compression spring (52) can be mounted on the tool suspension device.

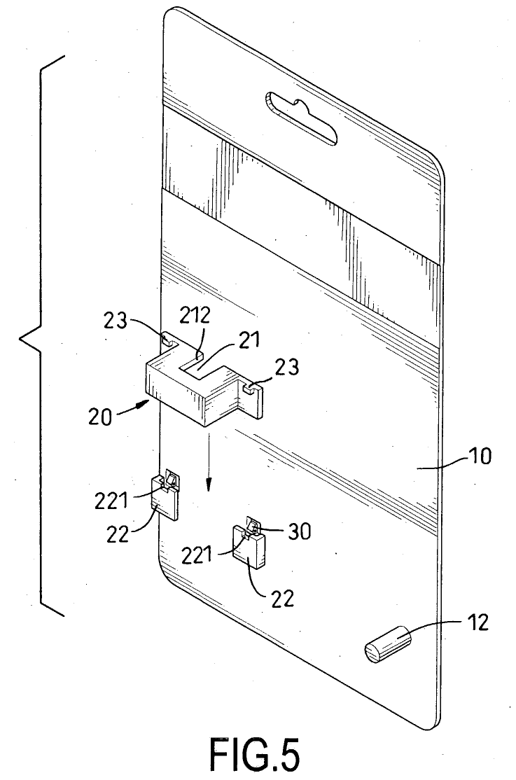

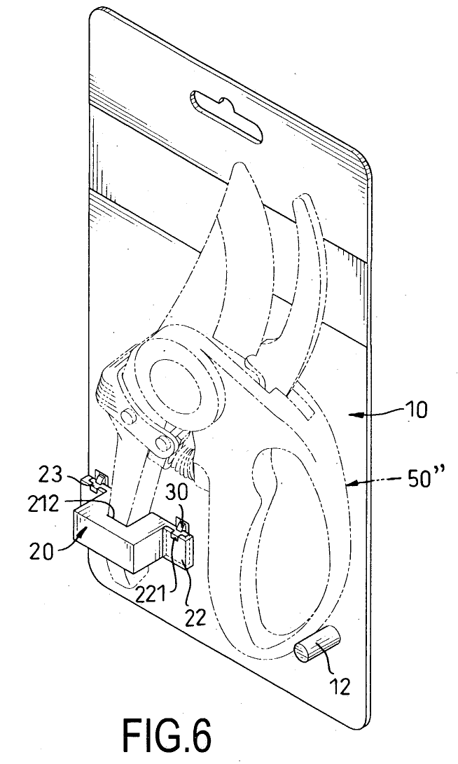

With reference to FIGS. 5 and 6, a second embodiment of the tool suspension device in accordance with the present invention has two clamping members (30) mounted on the front of the suspension board (10) to securely hold the bracket (21) on the holders (22). Each clamping member (30) has an inclined top (not numbered) and is respectively formed on the front of the suspension board (10) corresponding to the notch (221) in the holder (22). The clamping members (30) keep the bracket (21) from moving vertically while the bracket (21) securely hold one handle (not numbered) of a pair of pruning shears (50″). Because the clamping members (30) clamp the bracket (21) in the holders (22), the deforming slot defined at each side of the bracket (21) and the hook (241) in the first embodiment of the tool suspension device do not need to be implemented.

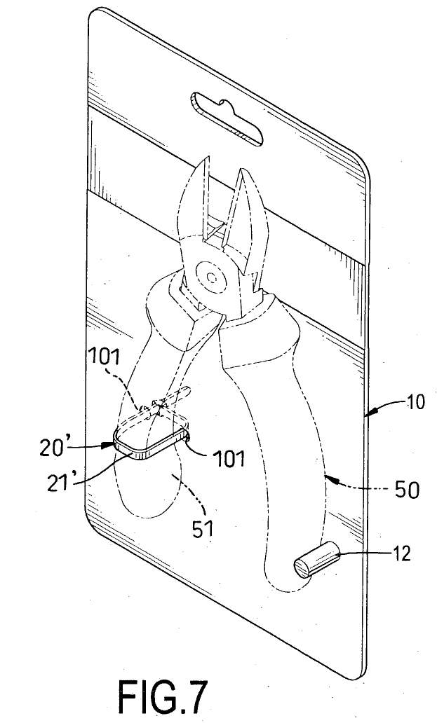

With reference to FIG. 7, a third embodiment of the tool suspension device in accordance with the present invention has a holding assembly (20′) with a simple structure and is implemented with a simple pull tie (21′) and two holes (101). The two holes (101) are defined through the front of the suspension board (10) and correspond to one of the handles (51) of the pliers (50) that are attached to the front of the suspension board (10). The pull tie (21′) has a first end (not numbered) and a second end (not numbered), the first end passes through one hole (101), around the handle (51) and back through the other hole (101) from the front of the suspension board (10) and is attached to the second end of the pull tie (21′) to round a receiving hole (not numbered) to securely hold the handle (51).

The tool suspension device in accordance with the present invention allows a person to directly check and operate the pliers (50) without removing them from the tool suspension device. Furthermore, the tool suspension device does not compress the compression spring in some types of pliers. The shortcomings of the conventional tool suspension devices are overcome by the present invention.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tool suspension device for a tool having a first and a second handles that are pivotally jointed with each other at a pivot point, both the first and the second handle of the tool respectively have an end opposite the pivot point and the tool suspension device comprising:
a suspension board with a front, a right side, a left side, a top and a bottom; and
a holding assembly with a receiving hole mounted on the front of the suspension board, the receiving hole of which is smaller in size than the end of the first handle of the tool to be held whereby the first handle of the tool is tightly held in the receiving hole in the holding assembly.

2. The tool suspension device as claimed in claim 1, wherein the suspension board further comprises
a hanging hole defined through the front near the top of the suspension board and adapted to hang on a display stand; and
a handle stop mounted on the front near the right side of the suspension board corresponding to the holding assembly and adapted to abut the second handle of the tool to hold the tool on the front of the suspension board.

3. The tool suspension device as claimed in claim 1, wherein the holding assembly comprises
a bracket with a front, a top, a bottom and two opposite sides mounted on the front of the suspension board and the bracket having
a positioning stub protruding from the front adjacent to the top at each side of the bracket;
a deforming slot defined from the bottom of the bracket to form a resilient arm at each side of the bracket; and
a hook formed on the resilient arm at each side of the bracket; and
two L-shaped holders respectively mounted on the front of the suspension board corresponding to the resilient arms of the bracket and each holder having
a top,
a bottom,
a short end and
an elongated end,
where the short end of each holder is attached to the front of the suspension board and the elongated ends face each other, and a notch is defined in the top of each holder corresponding to the respective positioning stubs of the bracket;
wherein each positioning stub of the bracket is respectively received in the notch in one of the holders,
the resilient arms of the bracket are respectively held between the suspension board and the holders,
the hook on each resilient arm engages the bottom of a corresponding one of the holders, and
the receiving hole is defined through the top to the bottom of the bracket.

4. The tool suspension device as claimed in claim 1, wherein the holding assembly comprises
a bracket with a front, a top, a bottom and two opposite sides mounted on the front of the suspension board and the bracket having
a positioning stub protruding from the front adjacent to the top at each side of the bracket;
two L-shaped holders respectively mounted on the front of the suspension board corresponding to the bracket and each holder having
a top,
a bottom,
a short end and
an elongated end,
where the short end of each holder is attached to the front of the suspension board and the elongated ends face each other, and a notch is defined in the top of each holder corresponding to one of the positioning stubs of the bracket; and
a clamping member with an inclined top formed on the front of the suspension board corresponding to the notch of each holder;
wherein each positioning stub of the bracket is respectively received in the notch in one of the holders,
the bracket is held between the suspension board and the holders and is clamped by the clamping members, and
the receiving hole is defined through the top to the bottom of the bracket.

5. The tool suspension device as claimed in claim 1, wherein
the suspension board further having two holes respectively defined through the front of the suspension board; and the holding assembly comprises
a pull tie with a first end and a second end, the first end passing through one hole on the suspension board, through the other hole on the suspension board securely attaches to the second end of the pull tie to define a receiving hole adapted to tightly hold one of the handles of the tool.

6. The tool suspension device as claimed in claim 2, wherein the holding assembly comprises
a bracket with a front, a top, a bottom and two opposite sides mounted on the front of the suspension board and the bracket having
a positioning stub protruding from the front adjacent to the top at each side of the bracket;
a deforming slot defined from the bottom of the bracket to form a resilient arm at each side of the bracket; and
a hook formed on the resilient arm at each side of the bracket; and
two L-shaped holders respectively mounted on the front of the suspension board corresponding to the resilient arms of the bracket and each holder having
a top,
a bottom,
a short end and
an elongated end,
where the short end of each holder is attached to the front of the suspension board and the elongated ends face each other, and a notch is defined in the top of each holder corresponding to the respective positioning stubs of the bracket;
wherein each positioning stub of the bracket is respectively received in the notch in one of the holders,
the resilient arms of the bracket are respectively held between the suspension board and the holders,
the hook on each resilient arm engages the bottom of a corresponding one of the holders, and
the receiving hole is defined through the top to the bottom of the bracket.

7. The tool suspension device as claimed in claim 2, wherein the holding assembly comprises
a bracket with a front, a top, a bottom and two opposite sides mounted on the front of the suspension board and the bracket having
a positioning stub protruding from the front adjacent to the top at each side of the bracket;
two L-shaped holders respectively mounted on the front of the suspension board corresponding to the bracket and each holder having
a top,
a bottom,
a short end and
an elongated end,
where the short end of each holder is attached to the front of the suspension board and the elongated ends face each other, and a notch is defined in the top of each holder corresponding to one of the positioning stubs of the bracket; and
a clamping member with an inclined top formed on the front of the suspension board corresponding to the notch of each holder;
wherein each positioning stub of the bracket is respectively received in the notch in one of the holders,
the bracket is held between the suspension board and the holders and is clamped by the clamping members, and
the receiving hole is defined through the top to the bottom of the bracket.

8. The tool suspension device as claimed in claim 2, wherein
the suspension board further having two holes respectively defined through the front of the suspension board; and the holding assembly comprises
a pull tie with a first end and a second end, the first end passing through one hole on the suspension board, through the other hole on the suspension board securely attaches to the second end of the pull tie to define a receiving hole adapted to tightly hold one of the handles of the tool.
